(19) United States
(12) Patent Application Publication
(10) Pub. No.: US 2003/0158899 A1
(43) Pub. Date: Aug. 21, 2003

(54) Apparatus and methods for video distribution via networks

(76) Inventor: John Hughes, Bashingstoke Hampshire (GB)

Correspondence Address: Jonathan P Meyer, Motorola, Intellectual Property Section Law Department, 1303 East Algonquin Road, Schaumburg, IL, 60196, US

(21) Appl. No.: 09/958,258

(22) PCT Filed: Feb. 9, 2001
(86) PCT No.: PCT/EP01/01504

(30) Foreign Application Priority Data
Feb. 9, 2000 (GB) 0002880.3

(51) Int. Cl. G06F 15/16; H04N 7/173

(52) U.S. Cl. 709/205; 709/231; 725/87

(57) ABSTRACT

Apparatus for video distribution to receiving units (6) over a network N. The apparatus comprises a distribution unit (4) at which video signals are compressed for transmission using intraframe and interframe coding, and at least one intermediate unit (10) disposed in a signal path between the distribution unit (4) and one or more receiving units (6). The intermediate unit (10) is arranged for storing intraframe coded signals and supplying such stored signals to one or more receiving units (6) when predetermined conditions are satisfied.

### FIELD OF THE INVENTION

The present invention relates to apparatus and methods for video distribution via networks.

### BACKGROUND OF THE INVENTION

The transmission of video signals over communications networks is becoming more prevalent. There are particular problems involved in the transmission of video signals, not least because of the large amount of data contained in an image. In general, video signals must be compressed for distribution over wireless systems such as TETRA (Trans-European Trunked Radio), GSM (Global System for Mobile Communications) and UMTS (Universal Mobile Telecommunication System) and also for distribution via internet- and intranet IP (internet protocol) networks. This is necessary in order to allow the transmission of real time video because of the limited bandwidth which is available.

Most compression techniques attempt to reduce the amount of data which needs to be transmitted by only transmitting changes between one frame and the next. At the receiver, the previously decoded frame is used in conjunction with the details of the changes received to construct the current frame. Where video signals are sent in such a manner, the signals are said to be interframe coded because the coding relies on more than one frame.

At certain times however, it is necessary to send a complete frame rather than sending the changes between one frame and the next. This is necessary, for example, when transmission is initiated or when there is an abrupt change in scene and it becomes more efficient to send a complete frame than an indication of the changes which have taken place. It can also be necessary to send a complete frame when errors have occurred during transmission and it is impossible, at the receiver, to accurately regenerate the required image. Such a complete frame which has not been encoded using interframe coding is termed an I-frame. The data representing a complete frame is subjected to intraframe coding (i.e. coding using only the information within that frame) before transmission.

In practice, each frame is considered to consist of a number of macroblocks, each of which may be interframe or intraframe coded. An interframe coded macroblock is termed a P-macroblock. An intraframe coded macroblock is termed an I-macroblock.

It is desirable to minimise the number of I-frames which are sent, since in general I-frames are wasteful of bandwidth. Therefore, in an ideal situation it might be sufficient to send only a single I-frame at the start of the transmission. In practice however, such a method will not work on its own with 100% reliability. This is typically due to errors caused during transmission and/or processing, and/or P-macroblocks being lost in their entirety. An I-frame will therefore be required by the receiver every so often.

One known technique consists of sending I-frames/I-macroblocks at regular intervals to ensure that the or each receiver can periodically regain synchronisation if necessary. However, such a technique is disadvantageous because it is likely to be wasteful of bandwidth. This is because I-frames/I-macroblocks are probably being sent when they are not required.

In an alternative existing technique, the transmitter may be arranged to send I-frames/I-macroblocks only upon a specific request from a receiver. This ensures that the bandwidth occupied by the system only increases when necessary. However this method also has disadvantages because there is a delay between a receiver requesting an I-frame/I-macroblock and the receiver receiving it. This problem is particularly acute in networks where there is a substantial transmission delay. Further, it is often the case that those systems which suffer most from limited bandwidth also suffer from large transmission delays. Moreover in some applications delay is particularly unacceptable, for example if the video distribution system is being used by the emergency services.

Whichever of the above systems is used, further problems arise in the case of group communications. For example, a user attempting to join a group video session late will be unable to do so until an I-frame has been received following the elapsing of the relevant predetermined period, or following a specific request by the new user.

The plurality of receivers involved in a group communication session cause further difficulties to arise. With an increased number of receivers there is an increased chance that I-frames will be required. Therefore, if the system is such that each receiver can call for I-frames, there can be an even greater demand on bandwidth.

In general, the use of multicasting is attractive because it makes efficient use of network resources. The advantages of using multicasting transmission techniques for video distribution can be seen by comparing FIGS. 1 and 2. As shown in FIG. 1, when using standard transmission techniques to transmit across a network, the transmitter generates separate video streams for each of the receivers. Thus in the example shown in FIG. 1, since there are three receivers 1, three separate video streams A, B, C are generated and sent by the transmitter 2. On the other hand, where multicasting transmission techniques are used, as shown in FIG. 2, only a single video stream A is created by the transmitter 2. Then at each branch 3 in the network, a decision is made as to whether the video stream needs to be duplicated. In the case shown in FIG. 2, the video stream is duplicated three times at the branch 3 so that separate streams A′, A″, A′″ can be fed to each of the receivers 1.

It will be appreciated that the examples shown in FIGS. 1 and 2 represent highly simplified networks. Likewise it will be appreciated that the advantages involved in multicasting are further increased as the number of receivers is increased.

Where a group communications system is implemented using multicasting techniques there is a further consideration. In a multicasting system there is no independent channel between each transmitter and receiver. Instead, the paths between the transmitter and the receivers share common channels for at least part of their length. Thus, if an increased number of I-frames are called for from the transmitter, these will all travel along the common channels and prevent the full benefit of multicasting being obtained. The increased number of I-frames will tend to degrade the performance of the system for all receivers.

There is a need to obviate at least some of the problems associated with the prior art.

### SUMMARY OF THE INVENTION

According to one aspect of the present invention, there is provided apparatus for video distribution over a network, as claimed in claim 1.

According to another aspect of the invention, there is provided a method of video distribution over a network, as claimed in claim 12.

Such systems can allow delays to be reduced, can minimise the use of bandwidth and can allow greater advantage to be made of multicasting techniques. Further, the delay incurred by a new group member joining an existing video call can be significantly reduced compared with a system where a complete intracoded frame from a distribution unit must be waited for.

Further aspects of the invention are as claimed in the dependent claims.

Additional specific advantages are apparent from the following description and figures.

### BRIEF DESCRIPTION OF THE DRAWINGS

FIG. 1 shows a simplified video distribution system using standard transmission techniques, with a separate video stream for each receiver;

FIG. 2 shows a simplified video distribution system using multicasting transmission techniques;

FIG. 3 shows schematically a video distribution system embodying the present invention; and

FIG. 4 is a flow chart showing schematically the operation of an extremity multicasting router in the video distribution system shown in FIG. 3.

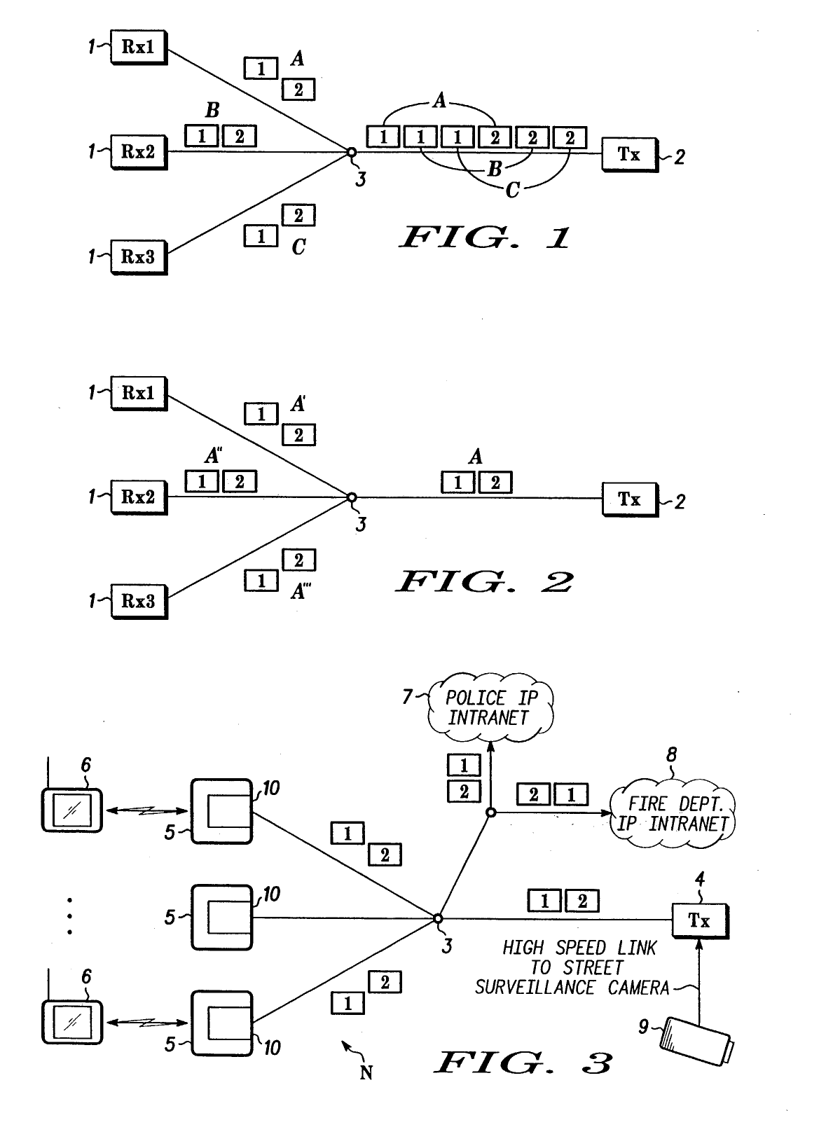

### DESCRIPTION OF EMBODIMENTS OF THE INVENTION

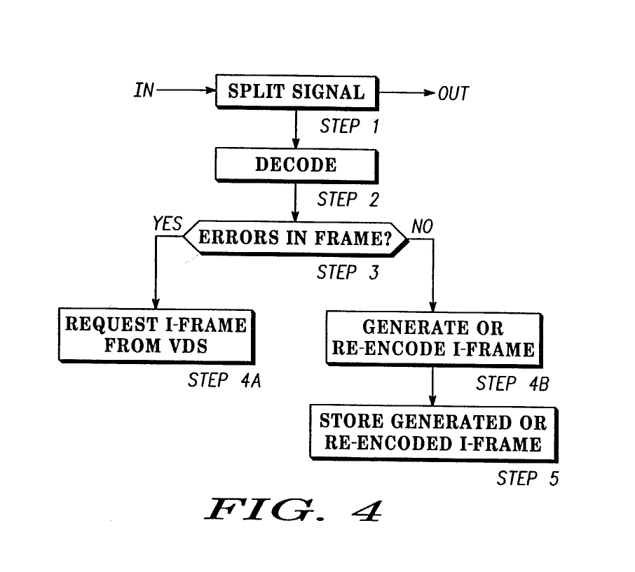

FIG. 3 shows an embodiment of the invention which is a multicasting video distribution system generally comprising a video distribution server 4 which acts as a central distribution unit and is connected via a communication network N to a plurality of remote receiving units. The remote receiving units may take various forms.

A plurality of base stations 5 are provided in the network N to distribute video signals to a plurality of wireless video receivers 6. The video distribution server 4 is also connected via the network N to a police IP intranet 7 and a fire department IP intranet 8. In this embodiment, the video receivers 6 and the police and fire department intranets 7, 8 together constitute the plurality of remote receiving units.

In the present case the video distribution system is used to distributed images taken by a street surveillance camera 9 to both the police and fire department intranets 7 and 8 and to the wireless video receivers 6. Whilst the remainder of the description will concern this particular application of the video distribution system, it will be appreciated that such a system and similar systems may be used in a large number of different circumstances where it is desired to transmit video images across communication networks from one location to another.

In the present embodiment the street camera 9 is connected to the video distribution server 4 via a conventional high speed link and no further consideration of the transfer of data between the camera 9 and the video distribution server 4 is given in this application.

At the video distribution server 4, the images to be transmitted are compressed using standard video compression techniques. Using these video compression techniques, I-frames, I-macroblocks and P-macroblocks are transmitted from the video distribution server 4 across the network N. These standard video compression techniques were described in the introduction. As described above, at each branch 3 in the network N, the system is arranged to duplicate the video stream as necessary in accordance with standard multicasting techniques.

In the present embodiment it is assumed that the connections between the video distribution server 4 and the police and fire department intranets 7 and 8 are of high quality, and thus no special measures are required to ensure a reliable and efficient transfer of data. Transmission of video images to the police and fire department intranets 7 and 8 is carried out as follows. At the start of a transmission, an I-frame is sent by the video distribution server 4 and received at the police and fire departments 7, 8. A number of P-macroblocks are then transmitted by the video distribution server 4 and decoded at the police and fire department intranets 7, 8 to generate subsequent frames. The receiving units at the police and fire department intranets 7, 8 are arranged to request I-frames/I-macroblocks as required to ensure the maintenance of synchronisation.

Standard techniques are used for communication between the video distribution server 4 and the police and fire department intranets 7 and 8. However, a different principle is used in communications between the video distribution server 4 and the wireless video receivers 6. The reason for this can be understood by considering the quality of transmission links in the system. There is assumed to be a high quality link between the video distribution server 4 and each of the base stations 5. However, wireless communication systems, such as those between the base stations 5 and each of the wireless video receivers 6, are inherently error prone. Thus the number of I-frames/I-macroblocks required by the wireless video receivers 6 is expected to be much higher than that which will be required by the police or fire departments' intranets 7, 8. The present embodiment of the invention avoids the need to transmit large numbers of I-frames/I-macroblocks across the whole of the network N to cope with the particular problems associated with transmitting to the wireless video receivers 6.

Although details are not shown in FIG. 3, in practical networks there will typically be a significant number of multicast routers provided between the video distribution server 4 and each of the base stations 5, as well as between the video distribution server 4 and the police and fire department intranets 7 and 8. Each of the base stations 5 also includes a multicast router 10, which for the purpose of this application is termed an ‘extremity multicast router’ 10. Each extremity multicast router 10 is typically far removed from the video distribution server 4 and is typically the final multicast router through which the video stream passes before being transmitted over a noisy and lossy medium, in this case a wireless network.

Each extremity multicast router 10 performs the functions of a standard multicast router as well as important functions as an intermediate unit which are specific to the video distribution system of the present invention. These are described in more detail below.

In the present embodiment of the invention, the system is configured to ensure that high quality links exist between the video distribution server 4 and each extremity multicast router 10. This ensures that the probability of errors occurring between the video distribution server 4 and the extremity multicast routers 10 is extremely low. Therefore it can be assumed that most of the frames arriving at each extremity multicast router 10 will be correct. In turn this means that synchronisation can be maintained at the extremity multicast routers 10 with a minimal number of I-frames being transmitted by the video distribution server 4.

FIG. 4 shows schematically the process undertaken by each extremity multicast router 10 upon receipt of a new video frame signal. At step 1 the extremity multicast router 10 performs its routing function and passes on the received packet to its intended destination, so as to introduce no delay in excess of that which would be generated by a standard router.

At step 2, an attempt is made to decode the frame. At step 3, it is determined whether any errors have occurred. If errors have occurred, then at step 4A, the extremity multicast router 10 requests an I-frame from the video distribution server 4. If on the other hand, no errors are detected in the frame, the information is used to generate a new I-frame at step 4B which is stored at the extremity multicast router 10 in step 5.

If the frame received from the video distribution server 4 is an I-frame, then the frame is merely re-encoded without further processing and stored. On the other hand, if the frame received from the video distribution server 4 consists of P-macroblocks, then the extremity multicast router 10 uses these macroblocks and the previously stored frame to generate a new frame. The resulting frame is stored and is in effect an I-frame. In accordance with the present invention therefore, the extremity multicast router 10 will maintain an up-to-date I-frame.

When one of the wireless video receivers 6 is receiving video signals from the video distribution server 4 and it detects that synchronisation has been lost or an I-frame is required for another reason, the video receiver 6 will issue a request for an I-frame. This request will typically be directed to the video distribution server 4. However, the request first has to pass through the extremity multicast router 10 located in the respective base station 5. In accordance with the present invention, each extremity multicast router 10 is arranged to intercept such request signals. The request, therefore, is not forwarded on to the video distribution server 4, but rather is acted on by the extremity multicast router 10. Thus in response to a request for an I-frame, the wireless video receiver 6 will receive the I-frame most recently stored in the respective extremity multicast router 10 in accordance with step 5 above.

This has advantages because the delay between a wireless video receiver 6 requesting an I-frame and receiving such an I-frame is influenced only by the transmission time over its wireless communication link rather than over the whole of the network back to the video distribution server 4. Further, rather than the I-frame being transmitted across the whole of the network and therefore affecting the quality of service received by all users, the I-frame is only transmitted over the respective wireless communications link. The system thus allows delays to be reduced, minimises use of bandwidth and allows greater advantage to be made of multicasting techniques.

In a situation where a multicast video call is already in progress and a further user wishes to join the call, the user's wireless video receiver 6 is arranged to request permission from the respective extremity multicast router 10 to join the group. This is done using IGMP (Internet Group Management Protocol) in the standard way for joining a multicast IP Group. The respective extremity multicast router 10 then ensures that the first video signal received by the new group member is the I-frame currently stored at the extremity multicast router 10. This reduces significantly the delay caused by the new group member to the network, compared with a prior art system where an I-frame has to be sent from the video distribution server 4. It also reduces the delay which the new group member experiences before having a viewable image frame.

Although in the present embodiment extremity multicast routers 10 are only provided in the base stations 5, it will be appreciated that such extremity multicast routers may be provided at any required location to provide the functions of an intermediate unit as described above. Another example of a noisy and error-prone medium might be a wireline communication system in a location such as a factory where interference is commonplace. In such a case, an extremity multicast router may be provided as the last router before the noisy wireline system is reached.

Whilst the present embodiment has been described with reference to a multicasting system and this is preferred, it should be noted that the present invention is equally applicable to systems using non-multicasting transmission techniques. Likewise, although it is preferred to arrange a router to perform the function of the intermediate unit, this is not essential.

1. Apparatus for video distribution to receiving units (6) over a network, the apparatus comprising:
a distribution unit (4) at which video signals are compressed for transmission using intraframe and interframe coding;
one or more receiving units (6);
at least one intermediate unit (10) disposed in a signal path between the distribution unit (4) and the one or more receiving units (6), the intermediate unit (10) being arranged for storing intraframe coded picture information and supplying said intraframe coded picture information to the one or more receiving units (6) when predetermined conditions are satisfied.

2. Apparatus according to claim 1 wherein the or each intermediate unit (10) is disposed in a signal path at, or adjacent to, a point where that signal path passes from a higher quality transmission medium to a lower quality transmission medium.

3. Apparatus according to claim 1 or claim 2 in which said at least one intermediate unit (10) comprises a router.

4. Apparatus according to claim 2 in which the or each intermediate unit (10) is located adjacent to, or comprises, a router which is the final router in a signal path before that path passes from a higher quality transmission medium to a lower quality transmission medium.

5. Apparatus according to any one of claims 1 to 4 in which the intermediate unit (10) is arranged to supply intraframe coded picture information in response to a request from a receiving unit (6).

6. Apparatus according to any preceding claim in which the intermediate unit (10) is arranged to store intraframe coded picture information received from the distribution unit (4).

7. Apparatus according to claim 6 in which the intermediate unit (10) is arranged to request intraframe coded picture information from the distribution unit (4) under predetermined circumstances.

8. Apparatus according to any preceding claim in which the intermediate unit (10) is arranged to generate and store intraframe coded picture information using interframe coded signals received from the distribution unit (4).

9. Apparatus according to any preceding claim in which said intraframe coded picture information comprises one or more complete intraframe coded frames.

10. Apparatus according to any preceding claim which is arranged for multicast video distribution.

11. Apparatus according to any preceding claim in which part or all of the network is an Internet Protocol network (N).

12. A method of video distribution over a network in which video signals are compressed at a distribution unit (4) using intraframe and interframe coding for transmission to receiving units (6), the method comprising the steps of:
storing intraframe coded picture information at at least one intermediate unit (10) disposed in a signal path between the distribution unit (4) and one or more receiving units (6); and
supplying said intraframe coded picture information from the distribution unit (4) to one or more receiving units (6) when predetermined conditions are satisfied.

13. A method according to claim 12 wherein the or each intermediate unit (10) is disposed in a signal path at a point where that signal path passes from a higher quality transmission medium to a lower quality transmission medium.

14. A method according to claim 12 or claim 13 in which said at least one intermediate unit (10) comprises a router.

15. A method according to claim 13 in which the or each intermediate unit (10) is disposed adjacent to, or comprises, a router which is the final router in a signal path before that path passes from a higher quality transmission medium to a lower quality transmission medium.

16. A method according to any one of claims 12 to 15 comprising the step of supplying intraframe coded picture information from the intermediate unit (10) in response to a request from a receiving unit (6).

17. A method according to any one of claims 12 to 16 comprising the step of storing, at the intermediate unit (10), intraframe coded picture information received from the distribution unit (4).

18. A method according to claim 17 comprising the step of the intermediate unit (10) requesting intraframe coded picture information from the distribution unit (4) under predetermined circumstances.

19. A method according to any one of claims 12 to 18 comprising the steps of generating and storing intraframe coded picture information at the intermediate unit (10) using interframe coded signals received from the distribution unit (4).

20. A method according to any one of claims 12 to 19 in which said intraframe coded picture information comprises one or more complete intraframe coded frames.

21. A method according to any one of claims 12 to 20 which is a method of multicast video distribution.

22. A method according to any one of claims 12 to 21 in which the network or at least part of the network is an Internet Protocol network (N).

23. Apparatus for video distribution to receiving units over a network (N) substantially as hereinbefore described with reference to, or as illustrated by FIG. 3 or FIG. 4.

24. A method of video distribution over a network substantially as hereinbefore described with reference to, or as illustrated by FIG. 3 or FIG. 4.
